(19) United States
(12) Patent Application Publication
(10) Pub. No.: US 2025/0357024 A1
(43) Pub. Date: Nov. 20, 2025

(54) VEHICLE HARNESS INSTALLATION IDENTIFIERS

(71) Applicant: GM GLOBAL TECHNOLOGY OPERATIONS LLC, Detroit, MI (US)

(72) Inventors: Mark A. Smith, Huntington Woods, MI (US); Miguel Arturo Saez, Clarkston, MI (US); Audrey Simms, Ferndale, MI (US); Robert J. Kliffel, Farmington Hills, MI (US); Frank R. Kuehnl, Pinckney, MI (US); Brian J. Haase, Warren, MI (US); Misty Ankney, Montpelier, OH (US); Vahidreza Molazadeh, Royal Oak, MI (US); Jesse K. Trudell, Harrison Township, MI (US)

(73) Assignee: GM GLOBAL TECHNOLOGY OPERATIONS LLC, Detroit, MI (US)

(21) Appl. No.: 18/665,924

(22) Filed: May 16, 2024

(51) Int. Cl. H01B 13/012; B60R 16/02

(52) U.S. Cl. CPC H01B 13/01209; B60R 16/0207

(57) ABSTRACT

A process and method for tagging identifiers in an automotive wire harness for recognition and installation. The process and method include attaching a plurality of first identifier tags to a wire harness, where each of the plurality of first identifier tags identifies a section of the wire harness. Continuing and identifying, based on the plurality of first identifier tags, a plurality of sections of the wire harness is accomplished. The wire harness is prepared for assembly into an automotive chassis, where the preparing includes, by section, an unfolding, flipping, or pulling of the wire harness, based on the plurality of first identifier tags. The process and method include attaching a plurality of second identifier tags to the automotive chassis, where each of the plurality of second identifier tags identifies a corresponding receptacle area associated with the one or more of the first identifier tags.

### INTRODUCTION

Vehicles are a staple of everyday life. Special use cameras, microcontrollers, laser technologies, and sensors may be used in many different applications in a vehicle. Cameras, microcontrollers, and sensors may be utilized in enhancing automated structures that offer state-of-the-art experience and services to the customers, for example in tasks such as automated parking, parking assist, body control, camera vision, information display, security, autonomous controls, etc.

With the advent of various electronics and control systems, the need to interconnect such systems becomes an ever increasingly complicated task. Such interconnections may take the form of multiple headed cable harnesses with connection receptacles located throughout the body and frame of a vehicle. Such harnesses may consist of multiple sections, cross-connections, receptacles, fasteners, and connectors. In some instances, a wire harness may require tedious, time-consuming unfolding, flipping, and pulling in order to properly orient all of the various sections for installation into a vehicle. Accordingly, it is desirable to produce a method for attaching identifier tags, codes, or other types of electronic and physical identifiers to aid in the wire harness installation process.

### SUMMARY

Disclosed herein are methods for tagging identifiers in an automotive wire harness for recognition and installation. An automotive harness may also apply to other forms of vehicles, for example, a type of aircraft, watercraft, or stationary system wire harness. The methods are applicable for identifying various sections, branch nodes, grounding terminals, tinned wire ends, or connectors of a wire harness, or other components as would be known by one of ordinary skill in the art. Further, reference to a wire harness, wiring harness, and harness, are not limited to just electrical connections but may include optical, mechanical, or other types of components as would be known by one of ordinary skill in the art. For example, a method may begin by attaching a plurality of first identifier tags to a wire harness, where each of the plurality of first identifier tags identifies a section of the wire harness. The method may continue identifying, based on the plurality of first identifier tags, a plurality of sections of the wire harness. The method may continue by preparing the wire harness for assembly into an automotive chassis, where the preparing may include, by section, an unfolding, flipping, or pulling of the wire harness, based on the plurality of first identifier tags. Then, the method may include attaching a plurality of second identifier tags to the automotive chassis, where each of the plurality of second identifier tags identifies a corresponding receptacle area associated with the one or more of the first identifier tags.

Another aspect of the method may include attaching each of the plurality of first identifier tags at a connection point of the wire harness.

Another aspect of the method may include where each of the plurality of first identifier tags includes one or more visual fiducial tags, for example an AprilTag.

Another aspect of the method may include where each of the plurality of first identifier tags includes an electronic tag.

Another aspect of the method may include where each of the plurality of first identifier tags includes a near field communication or ultrawide band communication device.

Another aspect of the method may include where each of the plurality of second identifier tags is attached at a connection point of the corresponding receptacle of the automotive chassis.

Another aspect of the method may include where each of the plurality of second identifier tags includes one or more visual fiducial tags.

Another aspect of the method may include where each of the plurality of second identifier tags includes an electronic tag.

Another aspect of the method may include where each of the plurality of second identifier tags includes a passive near field communication or an active ultrawide band communication device.

Another aspect of the method may include where the type of each of the plurality of first identifier tags is a same type as each of the plurality of second identifier tags.

Another aspect of the method may include where the type of each of the plurality of first identifier tags is a different type than each of the plurality of second identifier tags.

As disclosed herein is a method for preparing a wire harness for installation in an automotive chassis. The method may start by creating a plurality of first identifier tags on an automotive chassis, where each of the plurality of first identifier tags identifies a receptacle area associated with one or more connectors of the wire harness. The method may continue by receiving the wire harness, where a plurality of second identifier tags is attached to the wire harness, where each of the plurality of second identifier tags identifies a connector of the wire harness, and where each of the plurality of second identifier tags is associated with a corresponding receptacle area of the one or more first identifier tags in the automotive chassis. The method may continue by preparing the wire harness for assembly onto the automotive chassis, where the preparing includes, by section, an unfolding, flipping, or pulling of the wire harness, based on the plurality of second identifier tags.

Another aspect of the method may include where the plurality of first identifier tags includes a pressed or raised channel of a pattern or shape in the automotive chassis.

Another aspect of the method may include where each of the plurality of first identifier tags includes one or more visual fiducial tags, for example an AprilTag.

Another aspect of the method may include where each of the plurality of first identifier tags includes an electronic tag.

Another aspect of the method may include where each of the plurality of first identifier tags includes a near field communication or ultrawide band communication device.

Another aspect of the method may include where each of the plurality of first identifier tags includes one or more visual fiducial tags.

Another aspect of the method may include where each of the plurality of first identifier tags includes an electronic tag.

Another aspect of the method may include where the type of each of the plurality of first identifier tags is the same type as each of the plurality of second identifier tags.

Another aspect of the disclosure may include a method for tagging identifiers in an automotive wire harness for recognition and installation. The method may include attaching a plurality of first identifier tags to a wire harness, where each of the plurality of first identifier tags identifies a section of the wire harness and is attached at a connection point of the wire harness. Further, the method may include where each of the plurality of first identifier tags includes an identifier tag and by identifying, based on the plurality of first identifier tags, a plurality of sections of the wire harness. The method may include preparing the wire harness for assembly into an automotive chassis, where the preparing includes, by section, an unfolding, flipping, or pulling of the wire harness, based on the plurality of first identifier tags, and an attaching of a plurality of second identifier tags to an automotive chassis, where each of the plurality of second identifier tags identifies a corresponding receptacle area associated with one or more of the first identifier tags. Further, the method may include where each of the plurality of second identifier tags is attached at a connection point of the corresponding receptacle of the automotive chassis and where each of the plurality of second identifier tags includes a visual tag.

As used herein, the terms “vehicle” and “motor vehicle” may be used interchangeably and synonymously to include any relevant vehicle platform, such as passenger vehicles (ICE, HEV, FEV, fuel cell, fully and partially autonomous, etc.), commercial vehicles, industrial vehicles, tracked vehicles, off-road and all-terrain vehicles (ATV), motorcycles, farm equipment, aircraft, watercraft, spacecraft, e-bikes, etc. For non-automotive applications, disclosed wire harness concepts may be implemented for any logically relevant use, including commercial and residential power stations, electric vehicle supply equipment, photovoltaic systems, pumping equipment, wind turbine farms, server systems, etc.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, explain the principles of the disclosure.

FIG. 1 is an illustration of a wire harness assembly with multiple connecting points throughout the harness, in accordance with the disclosure.

FIG. 2 is an illustration of a wiring harness assembly with cross-connect harness portions, in accordance with the disclosure.

FIG. 3 is an illustration of an automotive chassis with corresponding locations to portions of a wiring harness, in accordance with the disclosure.

FIG. 4 is an illustration of a mating of connections of a wire harness with a vehicle chassis, in accordance with the disclosure.

FIG. 5 is an illustration of a mating of portions of a wire harness with a vehicle chassis, in accordance with the disclosure.

FIG. 6 is an illustration of visual fiducial tags located throughout a wire harness, in accordance with the disclosure.

FIG. 7 is an illustration of visual fiducial tags located throughout a vehicle chassis, in accordance with the disclosure.

FIG. 8 is a flowchart of a method for tagging identifiers in an automotive wire harness for recognition and installation, in accordance with the disclosure.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the intended application and use environment.

### DETAILED DESCRIPTION

The present disclosure is susceptible of embodiments in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function and/or perform the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

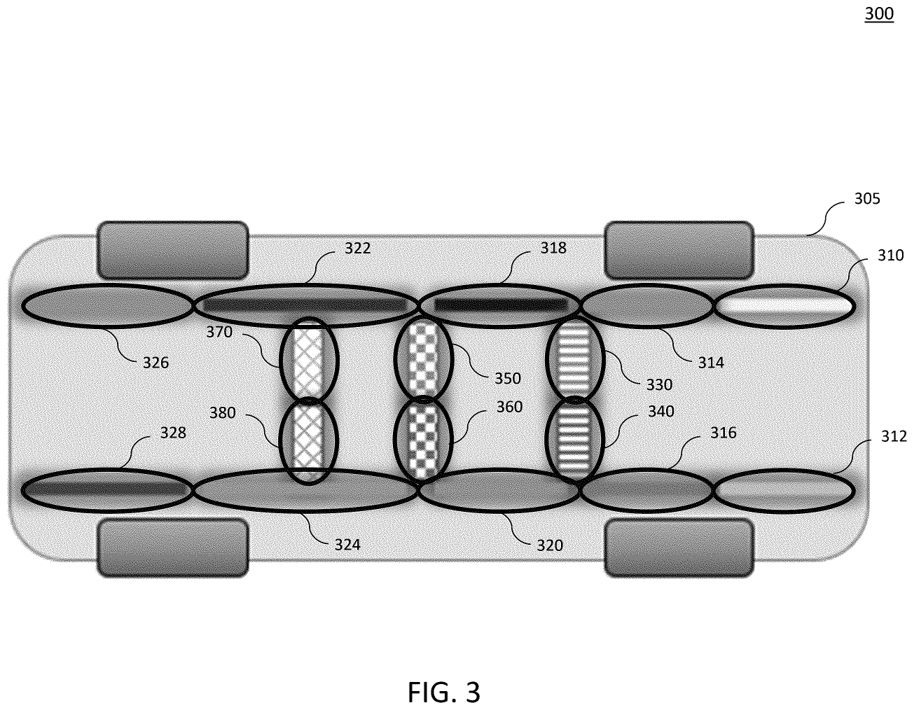

Referring to the drawings, the left most digit of a reference number identifies the drawing in which the reference number first appears (e.g., a reference number ‘310’ indicates that the element so numbered is first labeled or first appears in FIG. 3). Additionally, elements which have the same reference number, followed by a different letter of the alphabet or other distinctive marking (e.g., an apostrophe), indicate elements which may be the same in structure, operation, or form but may be identified as being in different locations in space or recurring at different points in time (e.g., reference numbers “110a” and “110b” may indicate two different input devices which may be functionally the same, but may be located at different points in a simulation arena).

Vehicles have become computationally advanced and equipped with multiple microcontrollers, sensors, processors, radars, LiDARs, cameras, and control systems, including for example, autonomous vehicle and advanced driver assistance systems (AV/ADAS) such as adaptive cruise control, automated parking, automatic brake hold, automatic braking, evasive steering assist, lane keeping assist, adaptive headlights, backup assist, blind spot detection, cross traffic alert, local hazard alert, and rear automatic braking may depend on information obtained from cameras and sensors on a vehicle. Such systems may also provide a wealth of information about the vehicle, including, for example, location, automatic assistance sensors, occupancy data, motion sensors, and last mile dead reckoning to name a few. These systems may also provide detailed data as to the operation and location of a vehicle. Such systems require the use of interconnections for power, communication, and control, for example the use of a wire harness installed within a vehicle chassis.

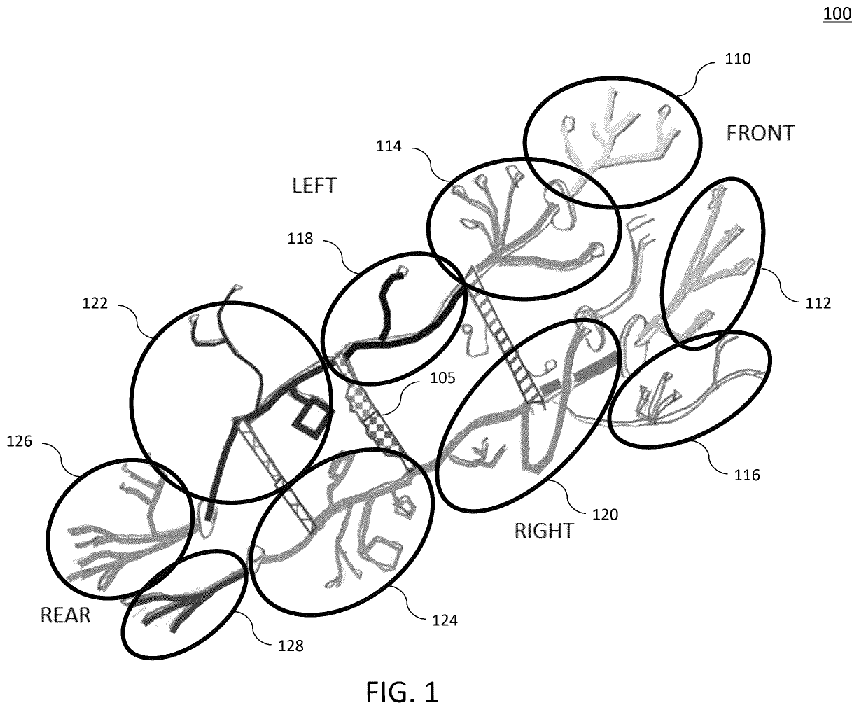

FIG. 1 is an illustration of a wire harness assembly 100 with multiple connecting points throughout the harness, according to an embodiment of the present disclosure. Wire harness 105 may include, as shown, multiple zones or portions that identify where each set of connections are to be placed within a vehicle chassis. A connection may be one or more of a type of connector, wire, terminal connector, etc. Wire harness 105 illustrates a harness with ten different zones or portions. Portion 110 is located at the front left, portion 112 at the front right, portion 114 at the near front left, portion 116 at the near front right, portion 118 at mid-point left, portion 120 at mid-point right, portion 122 at near rear left, portion 124 at near rear right, portion 126 at the rear left, and portion 128 at the rear right. In an embodiment, each portion of a wire harness may include one or more connectors, for example, including a male or female type connector, a lug, or a bare wire, or a other type of connector as would be known by one of ordinary skill in the art. A wire harness may include a number of portions or zones and still be within the scope of this disclosure. Furthermore, a wire harness may pertain to a type of vehicle or system, including but not limited to an automotive vehicle, aircraft, watercraft, or even a stationary system wire harness for a piece of equipment, machinery, appliance, or other type of device.

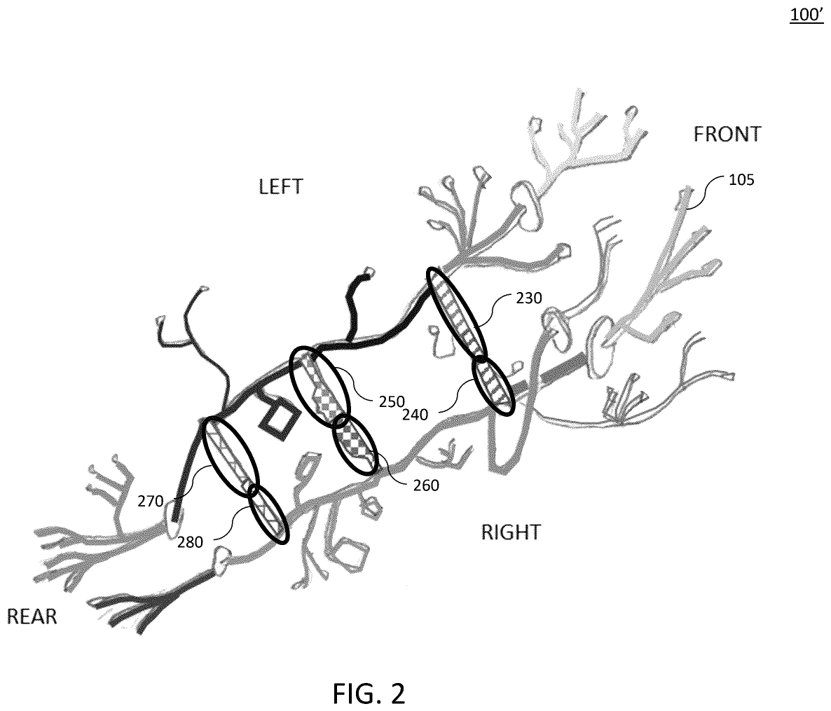

FIG. 2 is an illustration of a wire harness assembly 100′ with multiple connecting points throughout the harness, highlighting the cross-connect harness portions, according to an embodiment of the present disclosure. Wire harness assembly 100′ includes wire harness 105 with the additional cross-connect harness portions 230, 240, 250, 260, 270, and 280. In addition, as shown in FIG. 2, each portion may be marked or highlighted with various visual or electronic markings to identify each portion. For example, each portion may be marked with different reflective solutions, such that by looking at the wire harness 105, one could identify each portion. Such an observation may also be accomplished through mechanical means such as a robotic device with imaging capabilities.

FIG. 3 is an illustration of a vehicle chassis assembly 300, according to an embodiment of the present disclosure. Vehicle chassis assembly 300 may include corresponding zones or portions that link with the wire harness illustrated in FIG. 1 and FIG. 2. For example, vehicle chassis 305 may include the following portions or zones including receptacle portion 310 located at the front left, receptacle portion 312 located at the front right, receptacle portion 314 located at the near front left, receptacle portion 316 located at the near front right, receptacle portion 318 located at mid-point left, receptacle portion 320 located at mid-point right, receptacle portion 322 located at near rear left, receptacle portion 324 located at near rear right, receptacle portion 326 located at the rear left, and receptacle portion 328 located at the rear right. Vehicle chassis 305 may include locations for the cross-connect harness portions, for example, cross-connect harness portion receptacle locations 330, 340, 350, 360, 370, and 380. In addition, the word receptacle is not used to imply a particular type of connector, for example, a female or male type, but rather a corresponding connection.

FIG. 3 also illustrates the concept of marking or highlighting the vehicle chassis with corresponding visual or electronic markings to identify each portion of the vehicle chassis with its wire harness component. For example, the dark horizontal bars of cross-connect harness portion location 340 may be the same as cross-connect harness portion 240 of harness 105 shown in FIG. 2. Such corresponding visual or electronic markings may provide guidance to an individual or an automated system as to the intended placement of wire harness 105 with vehicle chassis 305. Either ends of the harness or the vehicle chassis may be marked with identifier tags, that may also include visual tags, fiducial tags, or an electronic tag. Example of identifier tags may include small visual fiducial tags containing position and orientation information such as AprilTags (originally developed by the University of Michigan under open source) that may be strategically attached on connectors, brackets, or other rigid sections on the wire harness that may also include a corresponding tag on the mating connector or body surface or chassis. Further, the corresponding body surface or chassis may include matching shapes, where the wiring harness may include shaped or marked areas that match similarly shaped or marked areas in the underbody, chassis, or body surface. In addition, an identifier tag may include reflective or infrared identifiers that may include a single or pattern of reflective target labels that may provide positional information and with the proper contrast in varied lighting or shadowed conditions, retroreflective targets may identify branches within the wire harness or receptacle locations within a chassis. In addition, identifier tags may include active transmission devices using short range communications, such as Bluetooth or radio frequency identification (RFID) that may be based on ultrawideband (UWB) or passive transmission using near field communications. In addition, the corresponding tagged channels in a vehicle chassis or underbody may exist in the form of (1) plastic channels with codes that come with the wiring harness and attach to underbody studs (2) stamped metal channels in the underbody, (3) uniquely shaped holes or clips in underbody to match corresponding sections of a wire harness.

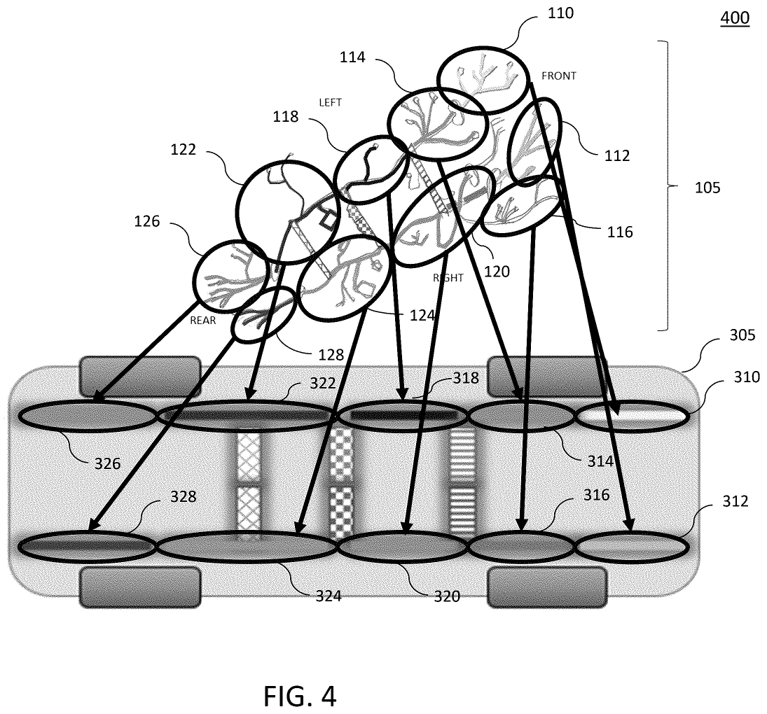

FIG. 4 is an illustration of a mating mapping 400 with connections of a wire harness and corresponding receptacle areas in a chassis, according to an embodiment of the present disclosure. FIG. 4 illustrates the wire harness discussed in FIG. 1 that includes wire harness 105 with multiple portions, where each portion may include one or more connectors of the same or different types of connectors. FIG. 4 illustrates wire harness 105 with its ten different zones or portions where, for example, portion 110 is located at the front left, portion 112 at the front right, portion 114 at the near front left, portion 116 at the near front right, portion 118 at mid-point left, portion 120 at mid-point right, portion 122 at near rear left, portion 124 at near rear right, portion 126 at the rear left, and portion 128 at the rear right. FIG. 4 also illustrates vehicle chassis 305, where vehicle chassis 305 may, in another embodiment, include a type of chassis or mounting surface in a vehicle, aircraft, watercraft, or stationary system with a wire harness. FIG. 4 illustrates the vehicle chassis with corresponding receptacle areas corresponding to the illustrated wire harness portions, for example, the portions or zones including receptacle portion 310 is located at the front left, receptacle portion 312 at the front right, receptacle portion 314 at the near front left, receptacle portion 316 at the near front right, receptacle portion 318 at mid-point left, receptacle portion 320 at mid-point right, receptacle portion 322 at near rear left, receptacle portion 324 at near rear right, receptacle portion 326 at the rear left, and receptacle portion 328 at the rear right.

As shown in FIG. 4, portion 110 of the wire harness located at the front left corresponds to the receptacle portion 310 located at the front left of vehicle chassis 305. In the same manner portion 112 of the wire harness located at the front right corresponds to the receptacle portion 312 located at the front right of vehicle chassis 305, portion 114 of the wire harness located at the near front left corresponds to the receptacle portion 314 located at the near front left of vehicle chassis 305, portion 116 of the wire harness located at the near front right corresponds to the receptacle portion 316 located at the near front right of vehicle chassis 305, portion 118 of the wire harness located at the mid-point left corresponds to the receptacle portion 318 located at the mid-point left of vehicle chassis 305, portion 120 of the wire harness located at the mid-point right corresponds to the receptacle portion 320 located at the mid-point right of vehicle chassis 305, portion 122 of the wire harness located at the near rear left corresponds to the receptacle portion 322 located at the near rear left of vehicle chassis 305, portion 124 of the wire harness located at the near rear right corresponds to the receptacle portion 324 located at the near rear right of vehicle chassis 305, portion 126 of the wire harness located at the rear left corresponds to the receptacle portion 326 located at the rear left of vehicle chassis 305, and portion 128 of the wire harness located at the rear right corresponds to the receptacle portion 328 located at the rear right of vehicle chassis 305.

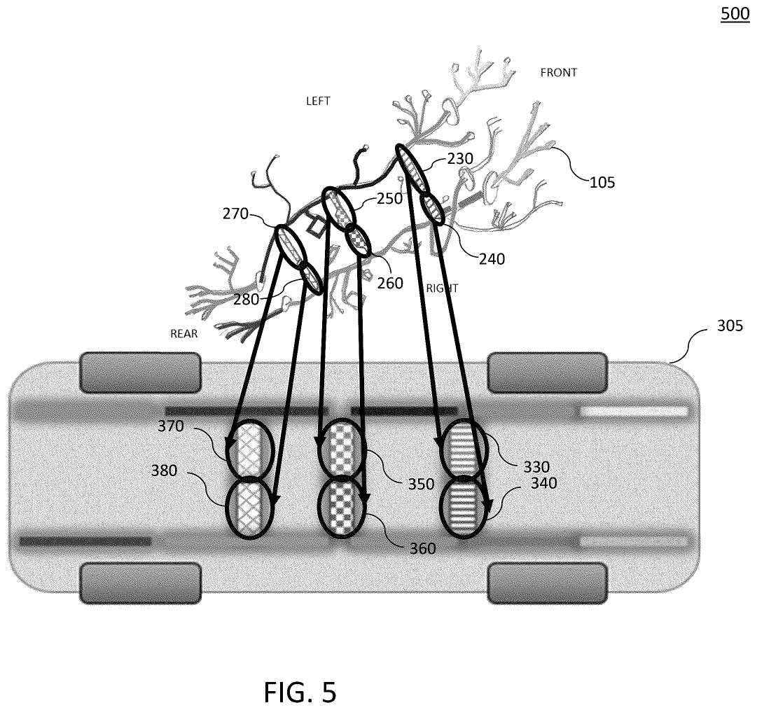

FIG. 5, in a similar concept to FIG. 4, illustrates a mating process 500 with cross-connect harness portions of a wire harness and corresponding receptacle areas in a chassis, according to an embodiment of the present disclosure. FIG. 5 illustrates wire harness 105 with the cross-connect harness portions 230, 240, 250, 260, 270, and 280 and cross-connect harness portion receptacle locations 330, 340, 350, 360, 370, and 380. As shown in FIG. 5, cross-connect harness portion 230 corresponds with cross-connect harness portion receptacle location 330, cross-connect harness portion 240 corresponds with cross-connect harness portion receptacle location 340, cross-connect harness portion 250 corresponds with cross-connect harness portion receptacle location 350, cross-connect harness portion 260 corresponds with cross-connect harness portion receptacle location 360, cross-connect harness portion 270 corresponds with cross-connect harness portion receptacle location 370, and cross-connect harness portion 280 corresponds with cross-connect harness portion receptacle location 380.

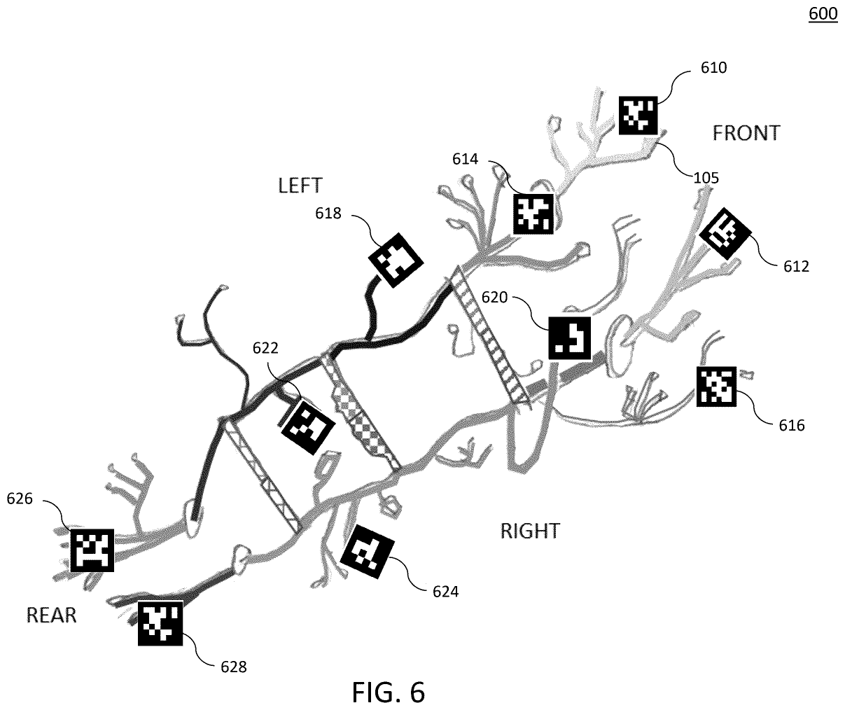

FIG. 6 illustrates the use of visual fiducial tags 600 located throughout a wire harness, according to an embodiment of the present disclosure. As discussed, the use of identifier tags may include the use of visual fiducial tags, containing position and orientation information such as AprilTags that may be strategically attached on connectors, brackets, or other rigid sections on the wire harness that may also include a corresponding tag on the mating connector or body surface or chassis. Further, the corresponding body surface or chassis may include matching shapes, where the wiring harness may include shaped or marked areas that match similarly shaped or marked areas in the underbody, chassis, or body surface. In addition, an identifier tag may include reflective or infrared identifiers that may include single or a pattern of reflective target labels that may provide positional information and with the proper contrast in varied lighting or shadowed conditions, retroreflective targets may identify branches within the wire harness or receptacle locations within a chassis. In addition, identifier tags may include active transmission devices using short range communications, such as Bluetooth or radio frequency identification (RFID) that may be based on ultrawideband (UWB) or passive transmission using near field communications. FIG. 6 illustrates an example of fiducial tags attached at various points on the wire harness 105. Specifically, in this example the tags are attached to specific points identifying each portion of the wire harness 105 as discussed in FIG. 1 and FIG. 4. Specifically, in this example fiducial tags 610, 612, 614, 616, 618, 620, 622, 624, 626, and 628 are placed in each zone or portion as illustrated in FIG. 1 and FIG. 4. The exact location of each fiducial tag is for example and may be placed as appropriate as desired and/or required during a manufacturing and installation process.

Placement of identifier tags, such as fiducial tags, may be accomplished in a multiple types or manners. For example, during the assembly or manufacturing process of the wire harness, an identifier tag may be located and attached manually, or automatically, for example by a robotic system. The same approach may be used for a vehicle chassis, or other type of chassis or structure, to which identifier tags may be attached. For example, during the manufacturing process of a chassis or structure, tags may be affixed to various positions as appropriate. Further, as some identifier tags are location, position, and orientation specific, the identifier tags may need to be placed in an appropriate location and orientation to allow for a correct installation process. In some embodiments there may be multiple identifier tags at a single location, for example, to aid in manually or automatically locating and identifying various portions of the wire harness from multiple angles and to further assist in an accurate acquiring and placement of the wire harness during installation.

Further, the placement of identifier tags on a wire harness may also aid in the manufacturing process, for example, after a wire harness has been manufactured and in preparation for installation into a vehicle chassis, or other structure. In some embodiments, the wire harness may be folded, compressed, wrapped, etc., into a compacted state. Thus, a preparation of the wire harness, without identifier tags, for assembly may involve time consuming labor to identify the various portions or zones of the wire harness and how to unfold and orient the various portions for installation into a vehicle chassis. With identifier tags, preparation of the wire harness for assembly may be aided in guiding, either manually or automatically via, for example, robotics, an unfolding, flipping, or pulling of the wire harness based on the identification and location of the identifier tags, into an acceptable layout or position for installation.

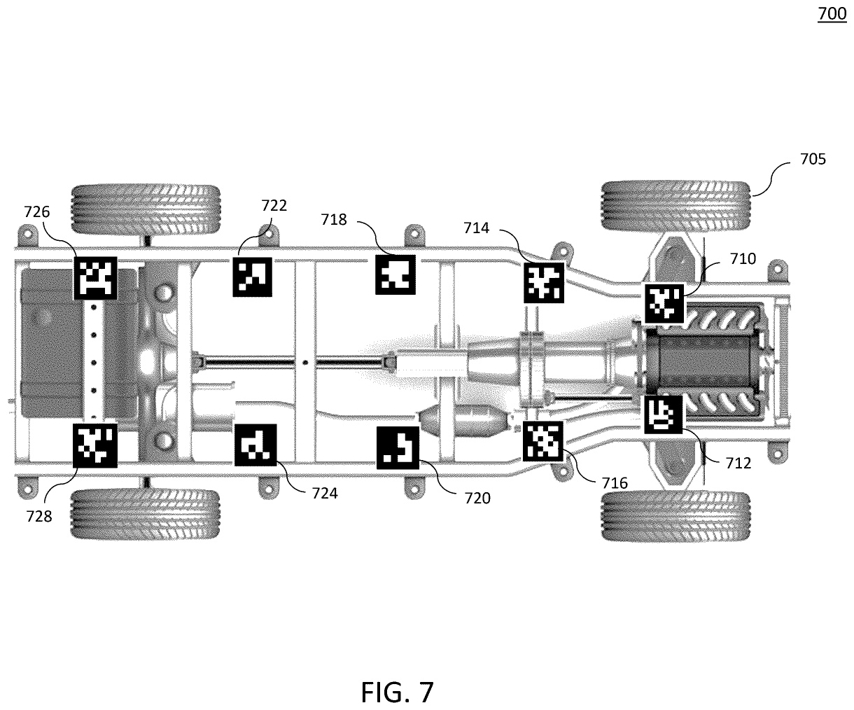

FIG. 7 illustrates the use of visual fiducial tags 700 located throughout a vehicle chassis 705 according to an embodiment of the present disclosure. As discussed, the use of identifier tags may include the use of visual fiducial tags, containing position and orientation information such as AprilTags that may be strategically attached on connectors, brackets, or other rigid sections on a vehicle chassis or other structure that may also include a corresponding tag on an equivalent corresponding mating connector of a wire harness. Further, the corresponding body surface or chassis may include matching shapes, where the wiring harness may include shaped or marked areas that match similarly shaped or marked areas in the underbody, chassis, or body surface. For example, identifier tags 710, 712, 714, 716, 718, 720, 722, 724, 726, and 728 on chassis 705 may correspond and/or be associated with their respective counterparts in the wiring harness, for example the fiducial tags 610, 612, 614, 616, 618, 620, 622, 624, 626, and 628 shown in FIG. 6. Thus, identifier tag 710 on the chassis 705 may be associated with the fiducial tag 610 of the wiring harness. In a similar fashion, tag 712 may be associated with tag 612, tag 714 may be associated with tag 614, tag 716 may be associated with tag 616, tag 718 may be associated with tag 618, tag 720 may be associated with tag 620, tag 722 may be associated with tag 622, tag 724 may be associated with tag 624, tag 726 may be associated with tag 626, and tag 728 may be associated with tag 628.

In addition, an identifier tag may include reflective or infrared identifiers that may include single or a pattern of reflective target stickers that may provide positional information and with the proper contrast in varied lighting or shadowed conditions, retroreflective targets may identify receptacle locations within a chassis. In addition, identifier tags may include active transmission devices using short range communications, such as Bluetooth or radio frequency identification (RFID) that may be based on ultrawideband (UWB) or passive transmission using near field communications.

The use of identifier tags on a vehicle chassis or other structure may, in one embodiment, take the form of a casting or punching of a pattern. In another embodiment, an identifier tag may take the form of one or more pressed or raised channels, or other methodology as would be known of one of ordinary skill in the art.

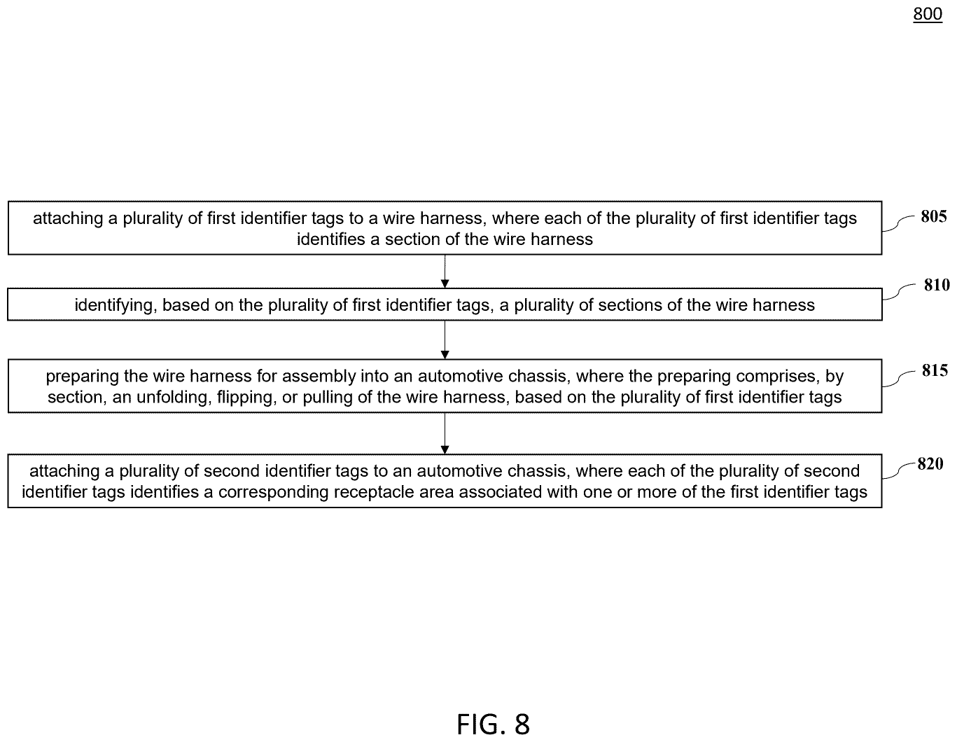

FIG. 8 shows an exemplary embodiment of method 800 for tagging identifiers in an automotive wire harness for recognition and installation, according to an embodiment of the present disclosure. Method 800 begins at step 805 by attaching a plurality of first identifier tags to a wire harness, where each of the plurality of first identifier tags identifies a section of the wire harness. As discussed in FIG. 1, the wire harness assembly 100 may have multiple connecting points through the harness. FIG. 1 illustrates a wire harness 105 with multiple zones or portions. Wire harness 105 illustrates a harness with ten different zones or portions. Portion 110 is located at the front left, portion 112 at the front right, portion 114 at the near front left, portion 116 at the near front right, portion 118 at mid-point left, portion 120 at mid-point right, portion 122 at near rear left, portion 124 at near rear right, portion 126 at the rear left, and portion 128 at the rear right. In an embodiment, each portion of a wire harness may include one or more connectors, for example, including a male or female type connector, a lug, or a bare wire, or an other type of connector as would be known by one of ordinary skill in the art. A wire harness may include a number of portions or zones and still be within the scope of this disclosure. Furthermore, a wire harness may pertain to a type of device including but not limited to an automotive vehicle, aircraft, watercraft, or even a stationary system wire harness for a piece of equipment, machinery, appliance, or other type of device.

As shown in FIG. 6, wire harness 105 of FIG. 1, is shown with the use of visual fiducial tags, containing position and orientation information such as AprilTags that may be strategically attached on connectors, brackets, or other rigid sections on the wire harness. Tags may also include retroreflective targets that may identify branches within the wire harness and may also include active transmission devices using short range communications, such as Bluetooth or radio frequency identification (RFID) that may be based on ultrawideband (UWB) or passive transmission using near field communications.

At step 810, the method may include identifying, based on the plurality of first identifier tags, a plurality of sections of the wire harness. As discussed in FIG. 6, a wire harness, after it has been assembled or manufactured, may be folded, compressed, wrapped, etc., into a compacted state and therefore presents difficulties in identifying its various sections or portions. Thus, a preparation of the wire harness, without identifier tags, for assembly may involve time consuming labor to identify the various portions or zones of the wire harness and how to unfold and orient the various portions for installation into a vehicle chasses.

Step 815 may include preparing the wire harness for assembly into an automotive chassis, wherein the preparing comprises, by section, an unfolding, flipping, or pulling of the wire harness, based on the plurality of first identifier tags. As mentioned above, preparation of the wire harness for installation, without identifier tags, may be a difficult, time-consuming task. Further, without the use of identifier tags the use of automated systems to prepare the wire harness for installation may not be feasible. However, with identifier tags, e.g., visual or fiducial tags, preparation of the wire harness for assembly may be aided in guiding, either manually or automatically via, for example, robotics, in identifying the multiple sections of wire harness in order to facilitate an unfolding, flipping, or pulling of the wire harness based on the identification and location of the identifier tags, into an acceptable layout or position for installation.

Step 820 may include attaching a plurality of second identifier tags to an automotive chassis, where each of the plurality of second identifier tags identifies a corresponding receptacle area associated with one or more of the first identifier tags. As discussed in FIG. 7, the use of identifier tags may include the use of visual fiducial tags, containing position and orientation information such as AprilTags that may be strategically attached on connectors, brackets, or other rigid sections on a vehicle chassis or other structure that may also include a corresponding tag on a mating connector of a wire harness. Further, the corresponding body surface or chassis may include matching shapes, where the wiring harness may include shaped or marked areas that match similarly shaped or marked areas in the underbody, chassis, or body surface.

Method 800 may then end.

The description and abstract sections may set forth one or more embodiments of the present disclosure as contemplated by the inventor(s), and thus, are not intended to limit the present disclosure and the appended claims.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof may be appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan considering the teachings and guidance.

The breadth and scope of the present disclosure should not be limited by the above-described exemplary embodiments.

Exemplary embodiments of the present disclosure have been presented. The disclosure is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the disclosure.

What is claimed is:

1. A method for tagging identifiers in an automotive wire harness for recognition and installation comprising:
attaching a plurality of first identifier tags to a wire harness, wherein each of the plurality of first identifier tags identifies a section of the wire harness;
identifying, based on the plurality of first identifier tags, a plurality of sections of the wire harness;
preparing the wire harness for assembly into an automotive chassis, wherein the preparing includes, by section, an unfolding, flipping, or pulling of the wire harness, based on the plurality of first identifier tags; and
attaching a plurality of second identifier tags to the automotive chassis, wherein each of the plurality of second identifier tags identifies a corresponding receptacle area associated with the one or more of the first identifier tags.

2. The method of claim 1, wherein each of the plurality of first identifier tags is attached at a connection point of the wire harness.

3. The method of claim 1, wherein each of the plurality of first identifier tags comprises one or more visual fiducial.

4. The method of claim 1, wherein each of the plurality of first identifier tags comprises an electronic tag.

5. The method of claim 1, wherein each of the plurality of first identifier tags comprises a near field communication or ultrawide band communication device.

6. The method of claim 1, wherein each of the plurality of second identifier tags is attached at a connection point of the corresponding receptacle of the automotive chassis.

7. The method of claim 1, wherein each of the plurality of second identifier tags comprises one or more visual fiducial.

8. The method of claim 1, wherein each of the plurality of second identifier tags comprises an electronic tag.

9. The method of claim 1, wherein each of the plurality of second identifier tag comprises a passive near field communication or an active ultrawide band communication device.

10. The method of claim 1, wherein a type of each of the plurality of first identifier tags is a same type as each of the plurality of second identifier tags.

11. The method of claim 1, wherein a type of each of the plurality of first identifier tags is a different type than each of the plurality of second identifier tags.

12. A method for preparing a wire harness for installation in an automotive chassis comprising:
creating a plurality of first identifier tags in an automotive chassis, wherein each of the plurality of first identifier tags identifies a receptacle area associated with one or more connectors of the wire harness;
receiving the wire harness, wherein a plurality of second identifier tags are attached to the wire harness, wherein each of the plurality of second identifier tags identifies a connector of the wire harness, and wherein each of the plurality of second identifier tags is associated with a corresponding receptacle area of the one or more first identifier tags in the automotive chassis; and
preparing the wire harness for assembly into the automotive chassis, wherein the preparing includes, by section, an unfolding, flipping, or pulling of the wire harness, based on the plurality of second identifier tags.

13. The method of claim 12, wherein the plurality of first identifier tags comprises a pressed or raised channel of a pattern or shape in the automotive chassis.

14. The method of claim 12, wherein each of the plurality of second identifier tags comprises one or more visual fiducial.

15. The method of claim 12, wherein each of the plurality of second identifier tags comprises an electronic tag.

16. The method of claim 12, wherein each of the plurality of second identifier tags comprises a near field communication or ultrawide band communication device.

17. The method of claim 12, wherein each of the plurality of first identifier tags comprises one or more visual fiducial tags.

18. The method of claim 12, wherein each of the plurality of first identifier tags comprises an electronic tag.

19. The method of claim 12, wherein a type of each of the plurality of first identifier tags is a same type as each of the plurality of second identifier tags.

20. A method for tagging identifiers in an automotive wire harness for recognition and installation comprising:
attaching a plurality of first identifier tags to a wire harness, wherein each of the plurality of first identifier tags identifies a section of the wire harness and is attached at a connection point of the wire harness, wherein each of the plurality of first identifier tags comprises a visual tag;
identifying, based on the plurality of first identifier tags, a plurality of sections of the wire harness;
preparing the wire harness for assembly into an automotive chassis, wherein the preparing includes, by section, an unfolding, flipping, or pulling of the wire harness, based on the plurality of first identifier tags; and
attaching a plurality of second identifier tags to an automotive chassis, wherein each of the plurality of second identifier tags identifies a corresponding receptacle area associated with one or more of the first identifier tags, wherein each of the plurality of second identifier tags is attached at a connection point of the corresponding receptacle of the automotive chassis, and wherein each of the plurality of second identifier tags comprises a visual tag.
